(19) United States
(12) Patent Application Publication
(10) Pub. No.: US 2007/0039993 A1
(43) Pub. Date: Feb. 22, 2007

(54) Cylinder structure of a nail driver

(76) Inventor: Chen-Fa Huang, Taichung Hsien (TW)

Correspondence Address: Chen-Fa Huang, 235 Chung - Ho, Box 8-24, Taipei, TW

(21) Appl. No.: 11/204,935

(22) Filed: Aug. 17, 2005

(51) Int. Cl. B25C 1/04

(52) U.S. Cl. 227/130

(57) ABSTRACT

A cylinder structure of a nail driver comprises a cylinder having a head and a body; the head having a first threaded area; and the body having a second threaded area which is engaged to the head. The head has a receiving portion for receiving a gun mouth and a nail cartridge and a pneumatic hole for guiding air to the gun mouth; and another end of the head has the first thread area and an annular insertion opening for connecting the body. A periphery of the body has a plurality of stop annular blocks and one end of the body has a through hole for being filled with air.

### FIELD OF THE INVENTION

The present invention relates to nail driver, and in particular to a cylinder structure of a nail driver, wherein components of the cylinder are formed individually. The inner thread and outer thread are used to combine the structure. The process is simple and cost is low.

### BACKGROUND OF THE INVENTION

In the prior art nail drive positioning structure, a cylinder structure is installed at a rear end of a top of the gun body. A flange of the cylinder is enclosed by a middle ring. The middle ring is received into a recess of a receiving chamber of the gun body. A buckling ring is installed between the wall of the recess and the middle ring so as to confine the middle ring. Thereby the cylinder is well positioned to the gun body.

In the prior art cylinder structure, the cylinder is formed integrally. Most of the cylinder has an I shape. In machining process, the recess must be formed at the inner wall of the gun body. The process is complicated and is difficult. Thereby the process is installed the buckling ring to be between the middle ring and the recess is very difficult. Thus the assembly work is hard.

### SUMMARY OF THE INVENTION

Accordingly, the primary object of the present invention is to provide a cylinder structure of a nail driver, wherein a components of the cylinder are formed individually. The inner thread and outer thread are used to combine the structure. The process is simple and cost is low.

To achieve above objects, the present invention provides a cylinder structure of a nail driver which comprises a cylinder having a head and a body; the head having a first threaded area; and the body having a second threaded area which is engaged to the head. The head has a receiving portion for receiving a gun mouth and a nail cartridge and a pneumatic hole for guiding air to the gun mouth; and another end of the head has the first thread area and an annular insertion opening for connecting the body. A periphery of the body has a plurality of stop annular blocks and one end of the body has a through hole for being filled with air.

The various objects and advantages of the present invention will be more readily understood from the following detailed description when read in conjunction with the appended drawing.

### BRIEF DESCRIPTION OF THE DRAWINGS

FIG. 1 is an exploded view of the cylinder structure of a nail driver of the present invention.

FIG. 2 is an assembled view of the cylinder structure of a nail driver of the present invention.

FIG. 3 is a cross sectional view about the cylinder structure of a nail driver of the present invention.

FIG. 4 is a schematic perspective view of the stop annular block of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

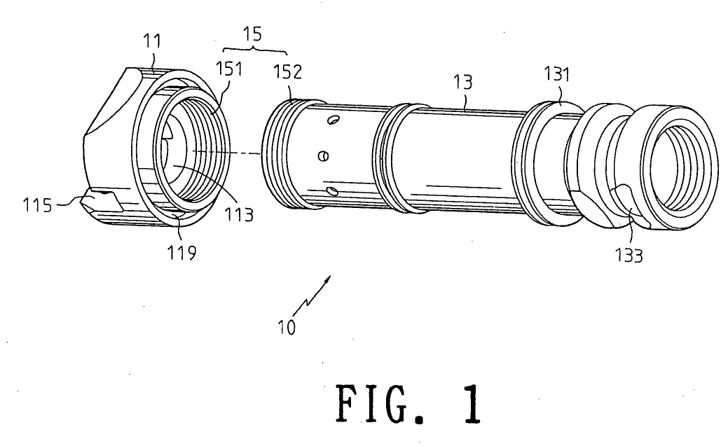

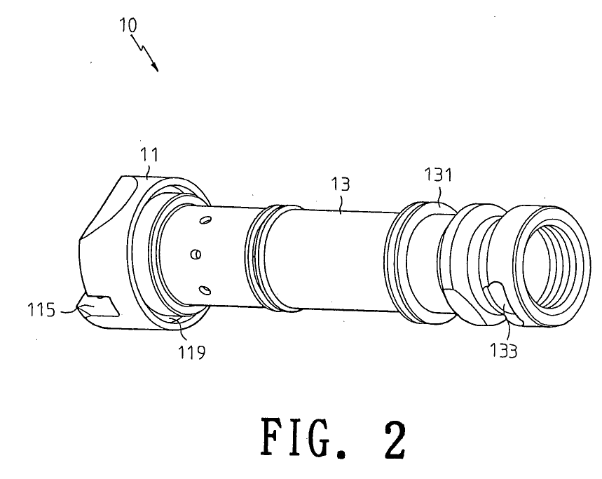

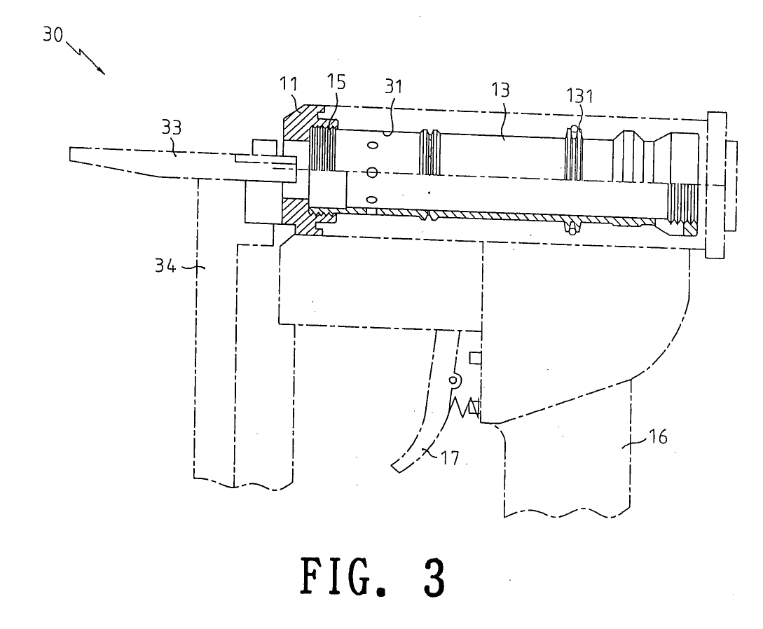

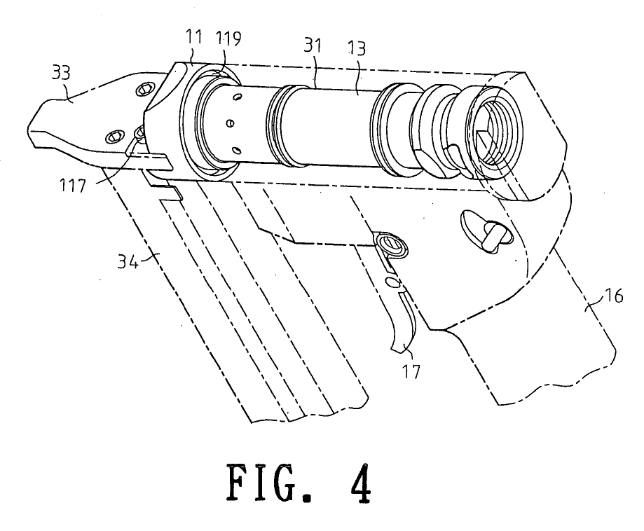

Referring to FIGS. 1 to 4, the cylinder structure of a nail driver of the present invention is illustrated. The cylinder structure of a nail driver has the following elements.

A cylinder 10 has a head 11 and a body 13.

The head 11 has a short round cylindrical shape with a hollow central portion and has a hollow pneumatic hole 113 and two receiving recesses 115 at one end wall of the head 11. Another end of the head 11 has an annular insertion opening 119 around the hollow central portion and an inner side of the head 11 is formed with inner thread 151.

The body 13 has a round cylindrical shape. An outer side of one end of the body 13 has an outer thread 152. The inner thread 151 and outer thread 152 are formed as a thread section 15. The inner thread 151 is threaded with the outer thread 152 so as to combine the body 13 into the head 11. An outer surface of the body 13 is formed with a plurality of stop annular blocks 131 (which is not the feature of the present invention, and thus the detail will not be described herein). A lateral side of another end of the head 11 has a through hole 133 for filling air into the body 13.

A gun unit 30 has a cylindrical wall 31 for receiving the body 13 of the cylinder 10. The gun unit 30 is received in the annular insertion opening 119. The gun unit 30 resists against one stop annular block 131 of the body 13. High pressure air is filled into the through hole 133 and then flows to the cylindrical wall 31 of the gun unit 30 so as to drive a firing pin. The gun unit 30 has a gun mouth 33 at one end of the cylindrical wall 31. The gun mouth 33 is received in the receiving recesses 115 and is fixed by the threaded portions 117 at the lateral side of the receiving recesses 115. Gas can flow into the gun mouth 33 to shot a nail.

The feature of the present invention is that the prior art cylinder is formed integrally, but in the present invention, the cylinder structure is formed by a plurality of detachable components. In the present invention, a nail cartridge 34 is assembled below the gun mouth 33. The cylinder structure is further assembled with a handle 16 and a trigger 17 and other air supply device (not shown). Thereby a nail driver is formed.

Furthermore, in the prior art, the receiving recess (such as 115 in the present invention) and the annular insertion opening (such as 119 in the present invention) are integral formed in the cylinder so that the process for forming the mold is complicated and cost is high. In the present invention, the components of the cylinder are formed individually. The inner thread 151 and outer thread 152 are used to combine the structure. The process is simple and cost is low.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A cylinder structure of a nail driver comprising:
a cylinder having a head and a body;
the head having a first threaded area;
the body having a second threaded area which is engageable to the head.

2. The cylinder structure of a nail driver as claimed in claim 1, wherein the head has a receiving portion for receiving a gun mouth and a nail cartridge and a pneumatic hole for guiding air to the gun mouth; and another end of the head has the first thread area and an annular insertion opening for connecting the body.

3. The cylinder structure of a nail driver as claimed in claim 1, wherein a periphery of the body has a plurality of stop annular blocks and one end of the body has a through hole for being filled with air.

4. The cylinder structure of a nail driver as claimed in claim 1, wherein:
the head has a short round cylindrical shape with a hollow central portion and has a hollow pneumatic hole and two receiving recesses at one end wall of the head; another end of the head has an annular insertion opening around the hollow central portion and an inner side of the head is formed with the first threaded area;
the body has a round cylindrical shape; an outer side of one end of the body has the second threaded area; the inner thread and outer thread are formed as a thread section; an outer surface of the body is formed with a plurality of stop annular blocks; a lateral side of another end of the head has a through hole for filling air into the body.

5. The cylinder structure of a nail driver as claimed in claim 4, further comprising: a gun unit having a cylindrical wall for receiving the body of the cylinder; the gun unit being received in the annular insertion opening; the gun unit resisting against one stop annular block of the body; wherein high pressure air is filled into the through hole and then flows to the cylindrical wall of the gun unit so as to drive a firing pin; the gun unit has a gun mouth at one end of the cylindrical wall; the gun mouth is received in the receiving recesses and are fixed by the threaded portions at the lateral side of the receiving recesses; and gas can flow into the gun mouth to shot a nail.
